(19) United States
(12) Patent Application Publication
(10) Pub. No.: US 2026/0318536 A1
(43) Pub. Date: Oct. 15, 2026

(54) GAS TURBINE AND GAS TURBINE FACILITY

(71) Applicant: MITSUBISHI HEAVY INDUSTRIES, LTD., Tokyo (JP)

(72) Inventors: Hiroyuki TAKEISHI, Tokyo (JP); Kozo AOKI, Tokyo (JP); Kazuaki HASHIGUCHI, Tokyo (JP); Akinori HAYASHI, Tokyo (JP); Hiromi KOIZUMI, Tokyo (JP); Hiroaki NAGAHASHI, Tokyo (JP); Satoshi TANIMURA, Tokyo (JP); Tomo KAWAKAMI, Tokyo (JP)

(21) Appl. No.: 18/998,768

(22) PCT Filed: Aug. 23, 2023
(86) PCT No.: PCT/JP2023/030288

§ 371 Date: Jan. 27, 2025

(30) Foreign Application Priority Data
Aug. 25, 2022 (JP) 2022-133982

(51) Int. Cl. F23R 3/26

(52) U.S. Cl. CPC F23R 3/26; F23R 2900/00002

(57) ABSTRACT

A gas turbine provided with a combustor that can switch fuel to be combusted between ammonia fuel and hydrocarbon-based fuel. The combustor has: a cylindrical body having a cylindrical shape and through which a combustion gas flows; a fuel nozzle through which ammonia fuel, hydrocarbon-based fuel and compressed air are emitted into the inside of the cylindrical body; an intermediate supply section which supplies a portion of the compressed air into the cylindrical body; and a flow amount adjustment section which can adjust the flow amount of the compressed air to be supplied into the cylindrical body. The flow amount adjustment section increases the flow amount of the compressed air to be supplied into the cylindrical body when it is intended to combust the ammonia fuel, and decreases the flow amount of the supply of compressed air into the cylindrical body when it is intended to combust the hydrocarbon-based fuel.

### TECHNICAL FIELD

The present disclosure relates to a gas turbine and gas turbine equipment.

This application claims the priority of Japanese Patent Application No. 2022-133982 filed in Japan on Aug. 25, 2022, the contents of which are incorporated herein by reference.

### BACKGROUND ART

A gas turbine includes a compressor that compresses air, a combustor that burns a fuel in the air compressed by the compressor to generate a combustion gas, and a turbine driven by the combustion gas. As the fuel supplied to the combustor, a hydrocarbon-based fuel, which is a fossil fuel such as natural gas or petroleum, is generally used, but ammonia may also be used.

For example, PTL 1 discloses a gas turbine that supplies ammonia as a main fuel and increases a ratio of a fossil fuel in the fuel supplied to the gas turbine in a combustion property deterioration operation region in which the combustion property of the ammonia is deteriorated, as compared with a case of a normal operation.

### CITATION LIST

### Patent Literature

[PTL 1] Japanese Unexamined Patent Application Publication No. 2010-19195

### SUMMARY OF INVENTION

### Technical Problem

The ammonia fuel has a small calorific value and a small combustion rate. That is, the ammonia fuel has a poorer combustion property than the hydrocarbon-based fuel. Therefore, in a gas turbine that can simultaneously supply the ammonia fuel and the hydrocarbon-based fuel, it is difficult to maintain stable combustion in a case where any of the ammonia fuel and the hydrocarbon-based fuel is supplied.

Further, in a case where ammonia is used as the fuel for the gas turbine, NOx is generated by a portion of nitrogen that forms ammonia during combustion. Therefore, a generation amount of NOx increases as a supply amount of the ammonia fuel supplied to the combustor becomes smaller than a supply amount of the compressed air, and the combustion is not effectively performed. On the other hand, when the hydrocarbon-based fuel is burned, NOx derived from nitrogen in the compressed air is generated. Therefore, a combustion temperature becomes higher and the generation amount of NOx becomes larger as the supply amount of the fuel or the air becomes closer to the stoichiometric amount, such as in a case where the supply amount of the hydrocarbon-based fuel to the combustor and the supply amount of the compressed air are close to each other. That is, in a case where the supply amount of the compressed air is set to the same condition in a case where the ammonia fuel is supplied and a case where the hydrocarbon-based fuel is supplied, it is difficult to suppress the generation amount of NOx.

The present disclosure provides a gas turbine and gas turbine equipment that can suppress a generation amount of NOx while continuing stable combustion with respect to a gas turbine to which an ammonia fuel and a hydrocarbon-based fuel are both supplied.

### Solution to Problem

An aspect of the present disclosure provides a gas turbine including: a compressor configured to compress air to generate compressed air; a combustor in which a fuel to be burned is switchable between an ammonia fuel and a hydrocarbon-based fuel, the combustor being configured to burn at least one of the ammonia fuel or the hydrocarbon-based fuel in the compressed air supplied from the compressor to generate a combustion gas; and a turbine drivable by the combustion gas supplied from the combustor, in which the combustor includes a cylindrical body that has a cylindrical shape and through which the combustion gas generated by combustion of the ammonia fuel or the hydrocarbon-based fuel flows, a fuel nozzle that jets the ammonia fuel, the hydrocarbon-based fuel, and the compressed air into the cylindrical body, an intermediate supply section that supplies a portion of the compressed air supplied to the fuel nozzle to the cylindrical body, on a downstream side of the fuel nozzle in a flow direction of the combustion gas, and a flow rate regulating section configured to regulate a flow rate of the compressed air supplied from the intermediate supply section to the cylindrical body with respect to a supply amount of the compressed air supplied to the fuel nozzle, and the flow rate regulating section increases the flow rate of the compressed air supplied from the intermediate supply section to the cylindrical body when the ammonia fuel is burned and decreases the flow rate of the compressed air supplied to the cylindrical body when the hydrocarbon-based fuel is burned.

Another aspect of the present disclosure provides gas turbine equipment including: the gas turbine described above; ammonia fuel supply equipment configured to supply the ammonia fuel to the gas turbine; and hydrocarbon-based fuel supply equipment configured to supply the hydrocarbon-based fuel to the gas turbine.

### Advantageous Effects of Invention

With the gas turbine and the gas turbine equipment according to the present disclosure, it is possible to suppress the generation amount of NOx while continuing stable combustion in the gas turbine to which the ammonia fuel and the hydrocarbon-based fuel are supplied.

### BRIEF DESCRIPTION OF DRAWINGS

FIG. 1 is a schematic configuration diagram of gas turbine equipment according to a first embodiment of embodiments of the present disclosure,

FIG. 2 is a schematic sectional view of a combustor according to the first embodiment of the present disclosure.

FIG. 3 is a schematic sectional view of a combustor according to a second embodiment of the present disclosure.

FIG. 4 is a cross-sectional view taken along line A-A of FIG. 3.

FIG. 5 is an enlarged view of a main part of the combustor of FIG. 3.

FIG. 6 is an enlarged view of a main part of a combustor of a modification example of the second embodiment corresponding to FIG. 5.

FIG. 7 is an enlarged view of a main part of a combustor according to a third embodiment corresponding to FIG. 5.

FIG. 8 is an enlarged view of a main part of a combustor according to a fourth embodiment corresponding to FIG. 5.

FIG. 9 is a schematic sectional view of a combustor according to a fifth embodiment of the present disclosure.

FIG. 10 is a cross-sectional view taken along line B-B of FIG. 8.

FIG. 11 is a first enlarged view of the main part of the combustor of FIG. 8.

FIG. 12 is a second enlarged view of the main pan of the combustor of FIG. 8.

FIG. 13 is a schematic sectional view of a combustor according to a sixth embodiment of the present disclosure.

FIG. 14 is a graph showing a ratio between supply amounts of an ammonia fuel and a hydrocarbon-based fuel and compressed air according to the sixth embodiment of the present disclosure.

FIG. 15 is a schematic sectional view of a combustor according to a seventh embodiment of the present disclosure.

### DESCRIPTION OF EMBODIMENTS

Hereinafter, embodiments for implementing a gas turbine 10 and gas turbine equipment 1 according to the present disclosure will be described with reference to the accompanying drawings. However, the present disclosure is not limited only to these embodiments.

### First Embodiment

### Configuration of Gas Turbine Equipment

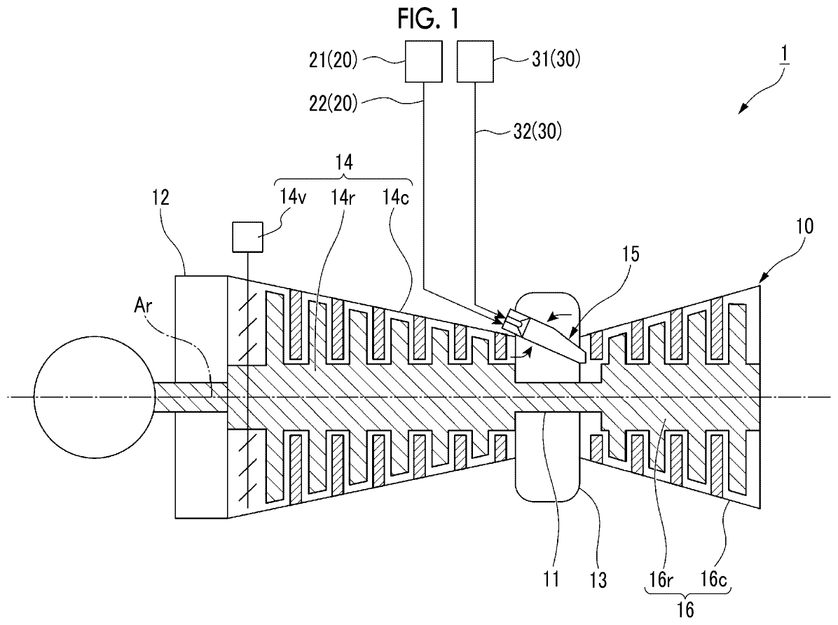

The gas turbine equipment 1 according to the present embodiment includes, as shown in FIG. 1, the gas turbine 10, ammonia fuel supply equipment 20, and hydrocarbon-based fuel supply equipment 30.

### Configuration of Gas Turbine

In the gas turbine 10, a fuel to be burned is switchable between an ammonia fuel and a hydrocarbon-based fuel. The gas turbine 10 can be driven by a combustion gas generated by burning at least one of the ammonia fuel and the hydrocarbon-based fuel. The gas turbine 10 according to the present embodiment includes a compressor 14, a combustor 15, a turbine 16, an air intake duct 12, and an intermediate casing 13.

The compressor 14 can compress air to generate compressed air. The compressor 14 includes a compressor rotor 14r that rotates about a rotor axis line Ar, a compressor casing 14c that covers the compressor rotor 14r, and an inlet guide vane (IGV) 14v that is provided in a suction port of the compressor casing 14c. The IGV 14v regulates an air intake amount, which is a flow rate of air sucked into the compressor casing 14c. The air intake duct 12 is connected to the suction port of the compressor casing 14c.

The turbine 16 can be driven by a high-temperature and high-pressure combustion gas supplied from the combustor 15. The turbine 16 includes a turbine rotor 16r that rotates about the rotor axis line Ar by using the combustion gas from the combustor 15, and a turbine casing 16c that covers the turbine rotor 16r. The turbine rotor 16r and the compressor rotor 14r are connected to each other to be rotatable about the same rotor axis line Ar and form a gas turbine rotor 11. For example, a rotor of a generator is connected to the gas turbine rotor 11.

The intermediate casing 13 is disposed between the compressor casing 14c and the turbine casing 16c in a direction in which the rotor axis line Ar extends, and connects the compressor casing 14c and the turbine casing 16e. The compressed air, which is discharged from the compressor 14, flows into the intermediate casing 13.

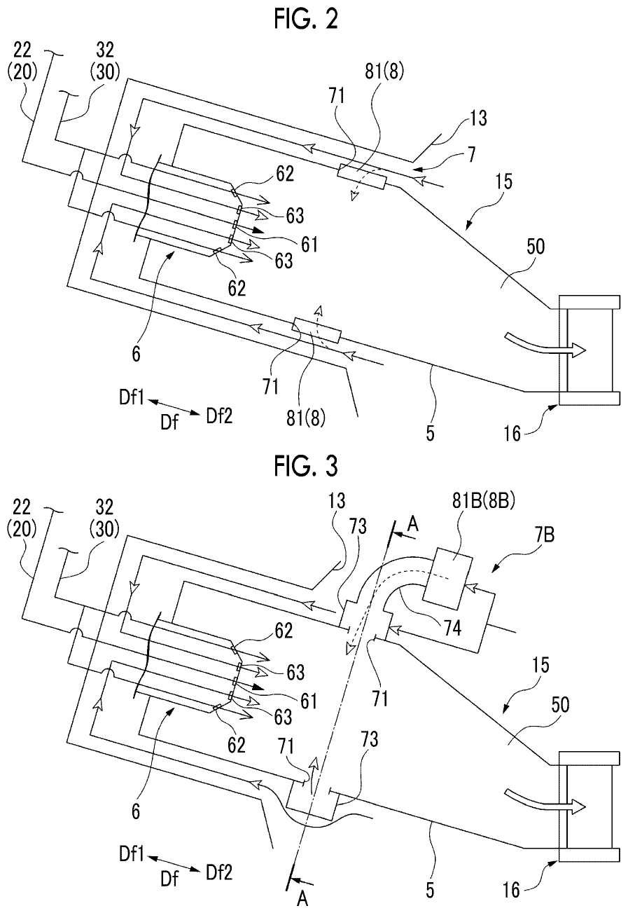

The combustor 15 can burn at least one of the ammonia fuel and the hydrocarbon-based fuel in the compressed air supplied from the compressor 14 to generate the combustion gas. The hydrocarbon-based fuel is a fuel containing a hydrocarbon and is, for example, a fossil fuel such as natural gas or petroleum. The ammonia fuel and the hydrocarbon-based fuel can be supplied to the combustor 15. The combustor 15 is operable under an operation condition in which only the ammonia fuel is burned, an operation condition in which only the hydrocarbon-based fuel is burned, and an operation condition in which both the ammonia fuel and the hydrocarbon-based fuel are burned, by regulating the supply amounts of the ammonia fuel and the hydrocarbon-based fuel, which are the fuels, depending on an operation situation. In the operation condition in which both the ammonia fuel and the hydrocarbon-based fuel are burned, the supply amount of the ammonia fuel and the supply amount of the hydrocarbon-based fuel may be the same as each other or different from each other. The combustor 15 is fixed to the intermediate casing 13. As shown in FIG. 2, the combustor 15 according to the present embodiment includes a cylindrical body 5, a fuel nozzle 6, an intermediate supply section 7, and a flow rate regulating section 8.

The cylindrical body 5 forms a combustion chamber 50 therein. The combustion chamber 50 is a space inside the cylindrical body 5. That is, the combustion gas, which is generated by the combustion of at least one of the ammonia fuel and the hydrocarbon-based fuel, flows inside the cylindrical body 5. The cylindrical body 5 is disposed in the intermediate casing 13 into which the compressed air compressed by the compressor 14 flows In the combustion chamber 50, at least one of the ammonia fuel and the hydrocarbon-based fuel is supplied and burned together with the compressed air. The combustion gas generated by the combustion of at least one of the ammonia fuel and the hydrocarbon-based fuel flows through the combustion chamber 50 and is fed to the turbine 16. The cylindrical body 5 is formed in a cylindrical shape about a central axis line of the combustor 15. A structure of the cylindrical body 5 is not limited to a structure formed of only one member. The cylindrical body 5 may have a structure in which a plurality of members are disposed in a direction in which the central axis line extends.

The fuel nozzle 6 jets the ammonia fuel, the hydrocarbon-based fuel, and the compressed air into the combustion chamber 50. The fuel nozzle 6 ix fixed to one end portion (upstream end, first end portion) of the cylindrical body 5, which is disposed at a position separated from the turbine 16. The fuel nozzle 6 jets the ammonia fuel, the hydrocarbon-based fuel, and the compressed air into the combustion chamber 50 toward the turbine 16. The fuel nozzle 6 generates the combustion gas by performing diffusion combustion under three conditions of the ammonia fuel and the compressed air, the hydrocarbon-based fuel and the compressed air, and the ammonia fuel, the hydrocarbon-based fuel, and the compressed air. One fuel nozzle 6 is disposed inside the cylindrical body 5. The fuel nozzle 6 includes at least one (two in the present embodiment) first jetting hole 61 for jetting the ammonia fuel, at least one (one in the present embodiment) second jetting hole 62 for jetting the hydrocarbon-based fuel, and at least one (two in the present embodiment) third jetting hole 63 for jetting the compressed air.

The first jetting hole 61, the second jetting hole 62, and the third jetting hole 63 are formed in the fuel nozzle 6 to be independent of each other and to be separated from each other. The first jetting hole 61, the second jetting hole 62, and the third jetting hole 63 according to the first embodiment are formed such that the respective fluids are mixed until being jetted into the combustion chamber 50. The first jetting hole 61 jets the ammonia fuel introduced from the outside of the combustor 15 into the combustion chamber 50. The first jetting hole 61 is located at the center in a radial direction of the fuel nozzle 6. The second jetting hole 62 jets the hydrocarbon-based fuel introduced from the outside of the combustor 15 into the combustion chamber 50. The third jetting hole 63 jets the compressed air introduced from the inside of the intermediate casing 13 into the combustion chamber 50. The third jetting hole 63 is disposed between the first jetting hole 61 and the second jetting hole 62 in the radial direction of the fuel nozzle 6.

The first jetting hole 61, the second jetting hole 62, and the third jetting hole 63 are not limited to the structure in which the first jetting hole 61, the second jetting hole 62, and the third jetting hole 63 are disposed inside one fuel nozzle 6. The first jetting hole 61, the second jetting hole 62, and the third jetting hole 63 may have a structure in which the first jetting hole 61, the second jetting hole 62, and the third jetting hole 63 are formed in independent nozzles, respectively. That is, the fuel nozzle 6 may be composed of a plurality of nozzles. The fuel nozzle 6 may further have other structures such as a swirler.

A portion of the compressed air supplied to the fuel nozzle 6 is supplied to the cylindrical body 5 from a location other than the fuel nozzle 6 by the intermediate supply section 7. The intermediate supply section 7 is located in the intermediate casing 13. The intermediate supply section 7 is disposed at a position on a downstream side Df2 of the fuel nozzle 6 in a flow direction Df of the combustion gas. Here, the flow direction Df of the combustion gas is a direction from one end portion of the cylindrical body 5 on which the fuel nozzle 6 is disposed to the other end portion (downstream end, second end portion) connected to the turbine 16. Therefore, an upstream side DEI in the flow direction Df of the combustion gas is a side in the cylindrical body 5 on which the fuel nozzle 6 is disposed with respect to the turbine 16. In addition, the downstream side Df2 in the flow direction Df of the combustion gas is a side in the cylindrical body 5 on which the turbine 16 is disposed with respect to the fuel nozzle 6. The intermediate supply section 7 according to the present embodiment includes a communication hole 71.

The communication hole 71 is formed to allow the combustion chamber 50, which is inside the cylindrical body 5, and the outside of the cylindrical body 5 at a position separated from the fuel nozzle 6 to communicate each other. That is, the communication hole 71 according to the present embodiment connects the combustion chamber 50 and a space in the intermediate casing 13 without passing through the fuel nozzle 6. The communication hole 71 is formed at a position on the downstream side Df2 of the fuel nozzle 6 in the flow direction Df of the combustion gas. The communication hole 71 is formed at a position that does not directly contribute to the diffusion combustion with respect to the combustion chamber 50 to supply the compressed air. The communication hole 71 is formed in the vicinity of the middle of the cylindrical body 5 in the flow direction Df. The communication holes 71 are formed at a plurality of positions (for example, four positions) separated from each other along an outer peripheral surface of the cylindrical body 5 in a circumferential direction of the cylindrical body 5. A plurality of communication holes 71 are disposed at equal intervals from each other. The communication hole 71 is formed in the middle of the flow channel of the compressed air introduced into the third jetting hole 63 in the intermediate casing 13. More specifically, in a case where a length of a straight line connecting a distal end of the fuel nozzle 6 to a position connected to the turbine 16 is set as a total length (100%) of the cylindrical body 5, it is preferable that the communication hole 71 is disposed between a position of 30% and a position of 70% from the distal end of the fuel nozzle 6.

In addition, the communication holes 71 are not limited to the structure in which the plurality of communication boles 71 are formed as in the present embodiment. Only one communication hole 71 may be provided. Further, the plurality of communication holes 71 are not limited to being disposed at equal intervals, and may be disposed at different intervals from each other.

The flow rate regulating section 8 can regulate the flow rate of the compressed air supplied from the intermediate supply section 7 to the cylindrical body 5 with respect to the supply amount of the compressed air supplied to the fuel nozzle 6. That is, the flow rate regulating section 8 can regulate a ratio between the supply amount of the compressed air indirectly supplied to the combustion chamber 50 together with the fuel via the third jetting hole 63 and the flow rate of the compressed air directly supplied from the intermediate supply section 7 to the combustion chamber 50. The flow rate regulating section 8 regulates the flow rate of the compressed air supplied from the intermediate supply section 7 to the combustion chamber 50 in accordance with the supply amounts of the ammonia fuel and the hydrocarbon-based fuel supplied to the fuel nozzle 6. Specifically, the flow rate regulating section 8 increases the flow rate of the compressed air supplied to the cylindrical body 5 when the ammonia fuel is burned. On the other hand, the flow rate regulating section 8 decreases the flow rate of the compressed air supplied to the cylindrical body 5 when the hydrocarbon-based fuel is burned. Further, the flow rate regulating section 8 according to the present embodiment includes a valve device 81.

The valve device 81 can regulate the flow rate of the compressed air flowing from the outside of the cylindrical body 5 to the combustion chamber 50 that is inside the cylindrical body 5. The valve device 81 is, for example, a flow rate regulation valve, an on-off valve, or an electromagnetic valve. The valve device 81 is disposed to block the communication hole 71. The valve device 81 regulates the flow rate of the compressed air passing through the communication hole 71. Specifically, an opening degree of the valve device 81 is increased (for example, may be in a fully open state) with an increase in the supply amount of the ammonia fuel to the first jetting hole 61. On the other hand, the opening degree of the valve device 81 is decreased (for example, may be in a fully closed state) with an increase in the supply amount of the hydrocarbon-based fuel to the second jetting hole 62. In addition, in a case where the ammonia fuel and the hydrocarbon-based fuel are simultaneously supplied, the valve device 81 regulates the opening degree in accordance with the amount of NOx, and the opening degree is the same as or intermediate to the opening degree in a case where only the ammonia fuel is supplied. That is, in a case of the simultaneous supply, the valve device 81 has an opening degree that is the same as or smaller than the opening degree in a case where only the ammonia fuel is supplied to the fuel nozzle 6, and has an opening degree that is larger than the opening degree in a case where only the hydrocarbon-based fuel is supplied to the fuel nozzle 6. A plurality of valve devices 81 according to the present embodiment are disposed such that one valve device SI is disposed with respect to one communication hole 71. That is, one valve device 81 is disposed to be able to block only one communication hole 71.

### Configuration of Ammonia Fuel Supply Equipment

As shown in FIG. 1, the ammonia fuel supply equipment 20 can supply the ammonia fuel to the gas turbine 10. The ammonia fuel supply equipment 20 according to the present embodiment includes a first storage tank 21 and a first supply line 22.

The first storage tank 21 stores the liquid-state ammonia fuel. The first supply line 22 connects the first storage tank 21 and the fuel nozzle 6. The first supply line 22 heats and vaporizes the liquid-state ammonia fuel to supply the vaporized ammonia fuel to the first jetting hole 61. The first supply line 22 can regulate the amount of the ammonia fuel supplied to the first jetting hole 61. The first supply line 22 includes a heat exchanger (not shown) for vaporizing liquid-state ammonia, a pump (not shown) for increasing the pressure, a valve (not shown) for regulating the supply amount, and the like.

### Configuration of Hydrocarbon-Based Fuel Supply Equipment

The hydrocarbon-based fuel supply equipment 30 can supply the hydrocarbon-based fuel to the gas turbine 10. The hydrocarbon-based fuel supply equipment 30 according to the present embodiment includes a second storage tank 31 and a second supply line 32.

The hydrocarbon-based fuel is stored in the second storage tank 31. The second supply line 32 connects the second storage tank 31 and the fuel nozzle 6. The second supply line 32 heats and vaporizes the hydrocarbon-based fuel to supply the vaporized hydrocarbon-based fuel to the second jetting hole 62 in a case where the hydrocarbon-based fuel is in a liquid state. The amount of the hydrocarbon-based fuel supplied to the second jetting hole 62 can be regulated in the second supply line 32. In this case, the second supply line 32 includes a heat exchanger (not shown) for vaporizing the liquid-state hydrocarbon-based fuel, a pump (not shown) for increasing the pressure, a valve (not shown) for regulating the supply amount, and the like. In a case where the hydrocarbon-based fuel is stored in the second storage tank 31 in a gaseous state, the hydrocarbon-based fuel is supplied to the second jetting hole 62 as it is or is increased in pressure. In this case, the second supply line 32 includes a pump (not shown) for increasing the pressure of the gaseous-state hydrocarbon based fuel, a valve (not shown) for regulating the supply amount, and the like.

### Operations and Effects

As described above, in the gas turbine equipment 1 having the above-described configuration, there may be a case where only the ammonia fuel is supplied to the gas turbine 10, a case where only the hydrocarbon-based fuel is supplied, and a case where the ammonia fuel and the hydrocarbon fuel are supplied simultaneously.

First, in a case where only the ammonia fuel is supplied, the ammonia fuel is supplied from the first storage tank 21 to the fuel nozzle 6 through the first supply line 22. The ammonia fuel supplied to the fuel nozzle 6 is jetted into the combustion chamber 50 through the first jetting hole 61. In this case, the compressed air supplied to the fuel nozzle 6 via the intermediate casing 13 is jetted into the combustion chamber 50 from the third jetting hole 63. The hydrocarbon-based fuel is not jetted from the second jetting hole 62. As a result, the diffusion combustion of only the ammonia fuel and the compressed air is performed in the combustion chamber 50. Here, the combustion is not limited to the diffusion combustion, and may be combustion suitable for a form of the fuel nozzle 6. Therefore, the combustion form may be a combustion form close to premixed combustion instead of the diffusion combustion. At the same time, the valve device 81 is in a state of being widely opened. As a result, most of the compressed air in the intermediate casing 13 flows into the combustion chamber 50 from the communication hole 71. That is, a portion of the compressed air that is to be supplied to the third jetting hole 63 directly flows into the combustion chamber 50 from the communication hole 71. Therefore, in a case where only the ammonia fuel is supplied to the fuel nozzle 6, the flow rate of the compressed air supplied to the third jetting hole 63 can be reduced.

In addition, in a case where only the hydrocarbon-based fuel is supplied, the hydrocarbon-based fuel is supplied from the second storage tank 31 to the fuel nozzle 6 through the second supply line 32. The hydrocarbon-based fuel supplied to the fuel nozzle 6 is jetted into the combustion chamber 50 through the second jetting hole 62. In this case, the compressed air is jetted into the combustion chamber 50 from the third jetting hole 63. Further, the ammonia fuel is not jetted from the first jetting hole 61. As a result, only the hydrocarbon-based fuel and the compressed air are burned in the combustion chamber 50. At the same time, the valve device 81 is in a state of being slightly opened (or closed). As a result, the compressed air in the intermediate casing, 13 hardly flows into the combustion chamber 50 from the communication hole 71. That is, the compressed air that is to be supplied to the third jetting hole 63 flows into the combustion chamber 50 from the third jetting hole 63 without being substantially reduced. In such a manner, in a case where only the hydrocarbon-based fuel is supplied to the fuel nozzle 6, the flow rate of the compressed air supplied to the third jetting hole 63 can be increased.

Further, in a case where both the ammonia fuel and the hydrocarbon-based fuel are supplied, the ammonia fuel is supplied from the first storage tank 21 to the fuel nozzle 6 through the first supply line 22. At the same time, the hydrocarbon-based fuel is supplied from the second storage tank 31 to the fuel nozzle 6 through the second supply line 32. Therefore, the ammonia fuel is jetted into the combustion chamber 50 through the first jetting hole 61, and the hydrocarbon-based fuel is jetted into the combustion chamber 50 through the second jetting hole 62. In this case, the compressed air is jetted into the combustion chamber 50 from the third jetting hole 63. As a result, the three types of the ammonia fuel, the hydrocarbon-based fuel, and the compressed air are burned in the combustion chamber 50. At the same time, the valve device 81 has a medium opening degree. As a result, the amount of the compressed air in the intermediate casing 13 that flows in from the communication holes 71 is the same as or less than the amount thereof in a case where only the ammonia fuel is burned, and is larger than the amount thereof in a case where only the hydrocarbon-based fuel is burned. That is, the supply amount of the compressed air supplied to the third jetting hole 63 is not significantly increased or significantly decreased. Therefore, an appropriate amount of the compressed air is supplied to the third jetting hole 63 in a case where both the ammonia fuel and the hydrocarbon-based fuel are burned.

In the combustor 15 of the gas turbine 10 described above, in a case where the combustion gas is generated by using the ammonia fuel, the flow rate of the compressed air used for the diffusion combustion in the fuel nozzle 6 can be reduced. It is known that the ammonia fuel has a poor combustion property because the ammonia fuel has a smaller calorific value and a lower combustion rate than the hydrocarbon-based fuel. Therefore, in a case where the compressed air is supplied at the supply amount equal to or larger than the supply amount when burning the hydrocarbon-based fuel, it is difficult to burn (stably burn) the hydrocarbon-based fuel in a stable state, and the flame holding property cannot be maintained. However, as described above, the supply amount of the compressed air is reduced when the ammonia fuel is supplied to the fuel nozzle 6. As a result, in a case where the ammonia fuel is burned, it is possible to suppress the occurrence of un table combustion due to excessive supply of the compressed air. Accordingly, in a case where the ammonia fuel is burned, stable combustion can be continued and the flame holding property can be maintained.

In a case where the supply amount of the compressed air is reduced, the proportion of the ammonia fuel in the ratio between the supply amounts of the ammonia fuel and the compressed air is increased. As a result, as described above, the flame holding property is maintained when the ammonia fuel is burned, and the amount of the nitrogen component remaining in the combustion gas derived from the nitrogen in the ammonia fuel can be significantly reduced. Therefore, the generation amount of NOx when the ammonia fuel is burned can be suppressed.

Further, when the hydrocarbon-based fuel is used to generate the combustion gas, the flow rate of the compressed air used for the diffusion combustion can be Increased by the fuel nozzle 6. A larger amount of the compressed air is required for the hydrocarbon-based fuel than for the ammonia fuel in order to stably barn the hydrocarbon-based fuel. On the other hand, when the hydrocarbon-based fuel is supplied to the fuel nozzle 6, the supply amount of the compressed air to the fuel nozzle 6 is increased as compared with when the ammonia fuel is supplied to the fuel nozzle 6. As a result, it is possible to secure a required amount of the compressed air to be supplied to the fuel nozzle 6 when the hydrocarbon-based fuel is burned. Accordingly, even when the hydrocarbon-based fuel is burned, the stable combustion is continued, and thus the flame holding property can be maintained without causing a backfire or the like.

In a case where the supply amount of the compressed air is increased, the proportion of the hydrocarbon-based fuel in the ratio between the sup ply amounts of the hydrocarbon-based fuel and the compressed air is decreased. As a result, when the hydrocarbon-based fuel is burned, the flame holding property is maintained, the generation of a high-temperature region in the cylindrical body 5 is suppressed, and the amount of the nitrogen component remaining in the combustion gas derived from nitrogen in the compressed air can be significantly reduced. Therefore, the generation amount of NOx when the hydrocarbon-based fuel is burned can be suppressed.

In this way, in the gas turbine 10 to which the ammonia fuel and the hydrocarbon-based fuel are supplied, the generation amount of NOx can be suppressed while continuing stable combustion, regardless of whether the ammonia fuel or the hydrocarbon-based fuel is supplied. Therefore, it is possible to effectively achieve both the combustion with the ammonia fuel and the combustion with the hydrocarbon-based fuel.

Further, in the flow rate regulating section 8, the flow rate of the compressed air flowing into the cylindrical body 5 is regulated by the valve device 81. Therefore, the supply amount of the compressed air in a case where the ammonia fuel is supplied and in a case where the hydrocarbon-based fuel is supplied can be regulated by a simple configuration.

In addition, the compressed air is supplied through the communication hole 71 to the cylindrical body 5 from a position that is separated from the fuel nozzle 6 and that is located on the downstream side Df2 of the fuel nozzle 6 in the flow direction DE of the combustion gas. In the cylindrical body S, in the vicinity of the distal end of the fuel nozzle 6, a certain amount of space is required in order to efficiently burn the ammonia fuel, the hydrocarbon-based fuel, and the compressed air supplied from the fuel nozzle 6. However, the compressed air flows into the combustion chamber 50 from a position separated from the fuel nozzle 6 to the downstream side Df2 through the communication hole 71. Therefore, the compressed air that has flowed into the combustion chamber 50 from the communication hole 71 does not directly participate in the diffusion combustion. Therefore, a structure in which the compressed air can be supplied to the combustion chamber 50 while securing a space for stably burning the ammonia fuel and the hydrocarbon-based fuel supplied from the fuel nozzle 6 can be obtained by a simple configuration.

In particular, in the cylindrical body 5, a region from the distal end of the fuel nozzle 6 to 30% is often a space required for burning the fuel supplied from the fuel nozzle 6 or 6G. That is, the communication hole 71 according to the present embodiment is disposed at a position beyond the region in which the fuel supplied from the fuel nozzle 6 is completely burned. Therefore, a space for stably burning the fuel supplied from the fuel nozzle 6 can be more reliably secured.

Further, in the cylindrical body 5, in a case where a large amount of fuel is supplied from the fuel nozzle 6, oxygen deficiency occurs, and a surplus fuel that cannot be completely burned is fed to a downstream region. In this case, the surplus fuel is burned in a diluted air portion in a region of about 30% from a rear end of the cylindrical body 5 in the downstream region in the cylindrical body 5. As a result, by forming the communication hole 71 to face the region from the distal end of the fuel nozzle 6 to 70%, a region in which the surplus fuel is burned can be secured in the downstream region in the cylindrical body 5.

In addition, the communication holes 71 are formed at a plurality of positions separated from each other with respect to the cylindrical body 5. Therefore, the compressed air supplied to the vicinity of the middle of the cylindrical body 5 is supplied to the combustion chamber 50 without being largely biased to the vicinity of an inner peripheral surface of a part of the cylindrical body 5. In particular, since the communication holes 71 are disposed at equal intervals, the compressed air is supplied to the combustion chamber 50 in a nearly uniform pressure state. Therefore, the generation amount of NOx can be effectively suppressed while continuing stable combustion with high efficiency in a wide region of the combustion chamber 50, regardless of whether the ammonia fuel or the hydrocarbon-based fuel is supplied.

### Second Embodiment

Next, a second embodiment of the gas turbine equipment 1 according to the present disclosure will be described. In the following second embodiment, the configurations common to the configurations of the first embodiment will be denoted by the same reference numerals in the drawings, and description thereof will be omitted. In the second embodiment, the configurations of an intermediate supply section 7B and a flow rate regulating section 8B are different from the configurations in the first embodiment.

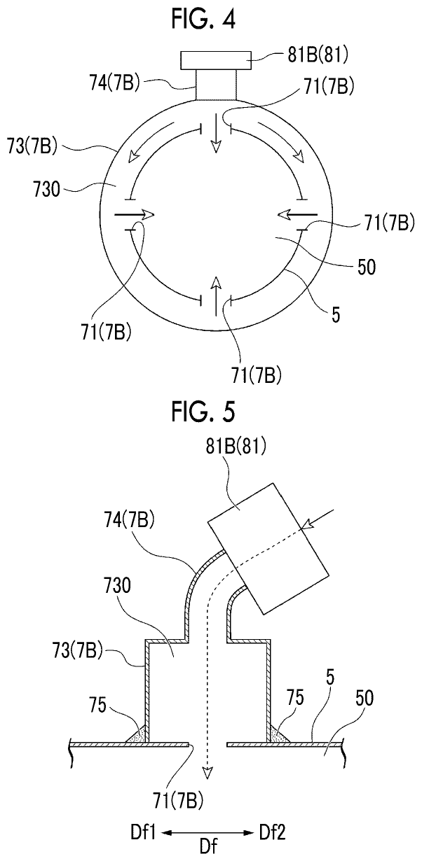

As shown in FIGS. 3 to 5, the intermediate supply section 7B according to the second embodiment includes an annular flow channel forming section 73 and a connection flow channel section 74. The annular flow channel forming section 73 is disposed in the intermediate casing 13. The annular flow channel forming section 73 forms an annular flow channel 730 through which the compressed air can flow along an outer periphery of the cylindrical body S. The annular flow channel forming section 73 covers the outer periphery of the cylindrical body S over the entire circumference. Therefore, the annular flow channel forming section 73 is disposed to cover the plurality of communication holes 71. The annular flow channel forming section 73 is directly fixed to the outer peripheral surface of the cylindrical body 5 without a gap by a welding section 75. Therefore, the communication hole 71 according to the present embodiment connects the combustion chamber 50 and the annular flow channel 730. The plurality of communication holes 71 are connected to each other outside the cylindrical body 5 by the annular flow channel 730. The connection flow channel section 74 connects the annular flow channel forming section 73 and a valve device 81B. The connection flow channel section 74 according to the present embodiment is a curved tubular member such a an elbow. The connection flow channel section 74 is formed such that a flow channel cross section thereof is smaller than a flow channel cross section of the annular flow channel 730. The connection flow channel section 74 is connected to a surface of the annular flow channel forming section 73 that is farthest from the cylindrical body 5. For example, an opening area at a connection position between the connection flow channel section 74 and the annular flow channel forming section 73 may be the same as or different from an opening area of the communication hole 71.

In the flow rate regulating section 8B according to the second embodiment, the valve device 81B is connected to the connection flow channel section 74. The valve device 81B is, for example, a flow rate regulation valve, an on/off valve, or an electromagnetic valve. That is, the valve device 81B regulates the flow rate of the compressed air supplied to the combustion chamber 50 from the annular flow channel 730 and the communication hole 71 by regulating the flow rate of the compressed air flowing into the connection flow channel section 74. Only one valve device 81B is disposed with respect to the connection flow channel section 74. That is, in the second embodiment, only one valve device SIB is disposed with respect to the plurality of communication holes 71.

### Operations and Effects

In the combustor 15 described above, a portion of the compressed air supplied to the intermediate casing 13 flows into the connection flow channel section 74 through the valve device 81B. The compressed air that has flowed into the connection flow channel section 74 flows into the annular flow channel forming section 73. In this case, the annular flow channel forming section 73 plays a role of a damper, and thus the compressed air present in the annular flow channel 730 is in a nearly uniform pressure state. Thereafter, the compressed air flows into the combustion chamber 50 from the plurality of communication holes 71 while filling the annular flow channel 730. Accordingly, the compressed air set to be in a nearly uniform pressure state in the annular flow channel forming section 73 can be supplied to the combustion chamber 50 from the plurality of communication boles 71. Therefore, the compressed air supplied from the plurality of communication holes 71 is supplied to the combustion chamber 50 in substantially the same pressure state at any position. Therefore, the generation amount of NOx can be further effectively suppressed while continuing stable combustion more efficiently in a wide region of the combustion chamber 50, regardless of whether the ammonia fuel or the hydrocarbon-based fuel is supplied. The compressed air can be uniformly supplied to the combustion chamber 50 by using only one valve device 81B. Therefore, in a case where a plurality of valve devices are used, it is possible to avoid the occurrence of variations in the supply state of the compressed air due to manufacturing tolerances or the like for each valve device.

The annular flow channel forming section 73 is not limited to the structure in which the outer periphery of the cylindrical body 5 is covered over the entire circumference. The annular flow channel forming section 73 may have a structure that covers only a part of the outer periphery of the cylindrical body 5. In addition, a cross-sectional area of the annular flow channel 730 is not limited to being the same over the entire circumference. The cross-sectional area of the annular flow channel 730 may partially change, such as a decrease in the middle, as long as a sufficiently large area can be secured with respect to the communication hole 71.

### Modification Example of Second Embodiment

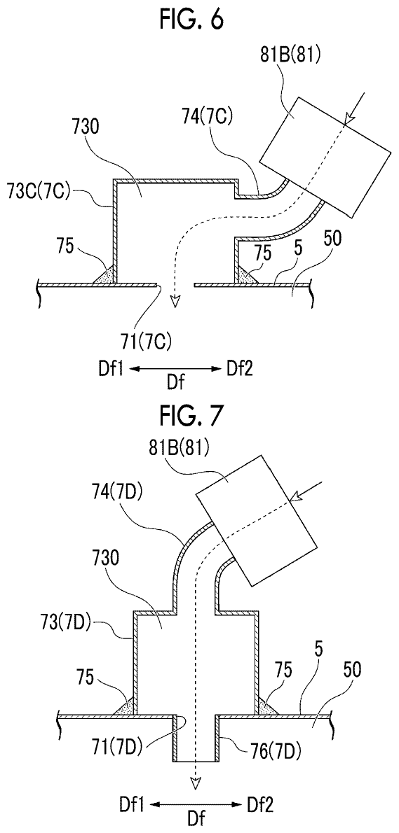

In the second embodiment, the position at which the connection flow channel section 74 is connected to the annular flow channel forming section 73 is not limited. The connection flow channel section 74 may be connected to a surface of the annular flow channel forming section 73 facing the flow direction Df of the combustion gas. In this case, for example, as shown in FIG. 6, a connection flow channel section 74C may be connected to a surface of the annular flow channel forming section 73 facing the downstream side Df2 in the flow direction Df of the combustion gas.

### Third Embodiment

Next, a third embodiment of the gas turbine equipment 1 according to the present disclosure will be described. In the following third embodiment, the configurations common to the configurations of the first and second embodiments will be denoted by the same reference numerals in the drawings, and description thereof will be omitted. In the third embodiment, as shown in FIG. 7, an intermediate supply section 7D includes a supply pipe 76. The supply pipe 76 is disposed in the communication hole 71. The supply pipe 76 is formed as a tubular member having the same shape as the communication hole 71. The supply pipe 76 is formed to extend inward from the inner peripheral surface of the cylindrical body 5. That is, the supply pipe 76 is disposed in a state of protruding from the inner peripheral surface of the cylindrical body 5 toward the inside of the cylindrical body 5. Accordingly, the supply pipe 76 supplies the compressed fluid present in the annular flow channel 730 to the vicinity of the center of the combustion chamber 50 separated from the inner peripheral surface of the cylindrical body 5. The supply pipe 76 may be disposed in all the communication holes 71 or in only some of the communication holes 71.

### Operations and Effects

Since the supply pipe 76 is disposed in this way, the compressed air flowing into the combustion chamber 50 from the communication hole 71 is fed to the vicinity of the center of the combustion chamber 50, deeper than the inner peripheral surface of the cylindrical body 5, by the supply pipe 76. Accordingly, the compressed air can be stably supplied to a deep portion of the combustion chamber 50 separated from the communication hole 71. Therefore, for example, even in a situation in which the compressed air supplied from the communication hole 71 immediately flows toward the downstream side Df2, such as in a case where the flow velocity of the combustion gas in the combustion chamber 50 is high, the compressed air can be supplied to the vicinity of the center of the combustion chamber 50. Therefore, even in a case where any one of the ammonia fuel and the hydrocarbon-based fuel is supplied, the occurrence of unburned substances or the occurrence of a local high-temperature region can be suppressed in a wide region of the combustion chamber 50. Therefore, it is possible to further effectively suppress the generation amount of NOx while continuing stable combustion more efficiently in a wide region of the combustion chamber 50.

### Fourth Embodiment

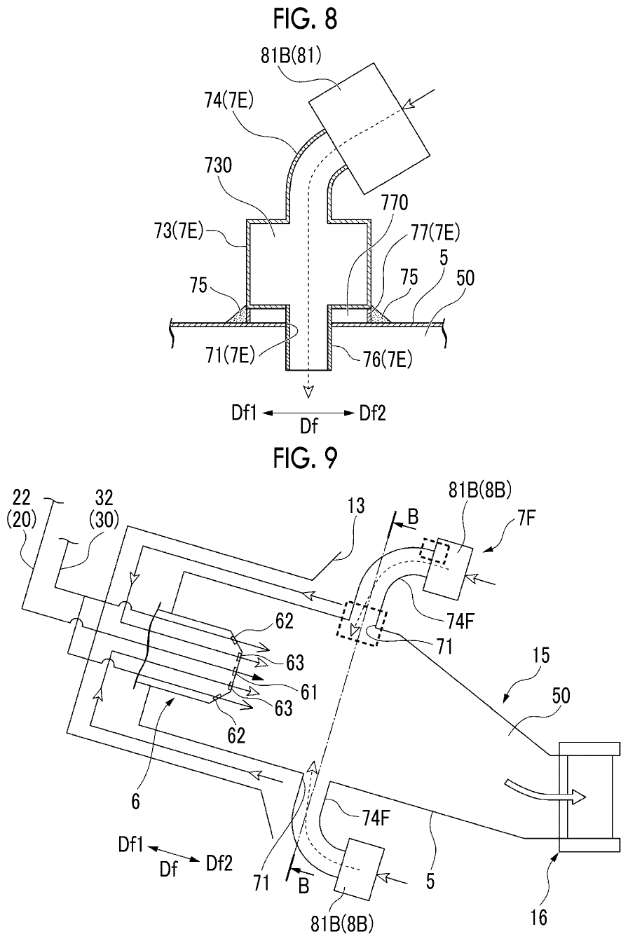

Next, a fourth embodiment of the gas turbine equipment 1 according to the present disclosure will be described. In the following fourth embodiment, the configurations common to the configurations of the first to third embodiments will be denoted by the same reference numerals in the drawings, and description thereof will be omitted. In the fourth embodiment, the annular flow channel forming section 73 is not limited to the structure directly connected to the outer peripheral surface of the cylindrical body 5 as in the second embodiment or the third embodiment. For example, as shown in FIG. 8, the annular flow channel forming section 73 may be disposed to have a gap 770 with the outer peripheral surface of the cylindrical body 5. Specifically, an intermediate supply section 7B has a gap forming member 77 that connects the annular flow channel forming section 73 and the cylindrical body 5. The gap forming member 77 forms the gap 770 between the annular flow channel forming section 73 and the outer peripheral surface of the cylindrical body 5. The gap forming member 77 is an annular member formed to cover the communication hole 71 on the outside of the cylindrical body 5. In the present embodiment, the gap 770 is a space sealed between the gap forming member 77, the annular flow channel forming section 73, and the cylindrical body S.

### Operations and Effects

As described above, the gap 770 is formed between the annular flow channel forming section 73 and the outer peripheral surface of the cylindrical body 5. Therefore, even in a case where thermal expansion of the cylindrical body 5 occurs due to the influence of the high-temperature combustion gas flowing through the combustion chamber 50, the thermal expansion amount can be absorbed without affecting the annular flow channel forming section 73. Accordingly, the fixed state of the annular flow channel forming section 73 and the cylindrical body 5 can be stably maintained.

### Fifth Embodiment

Next, a fifth embodiment of the gas turbine equipment 1 according to the present disclosure will be described. In the following fifth embodiment, the configurations common to the configurations of the first to fourth embodiments will be denoted by the same reference numerals in the drawings, and description thereof will be omitted. In the fifth embodiment, a structure of an intermediate supply section 7F is not limited to the structure including the annular flow channel forming section 73 as in the second to fourth embodiments.

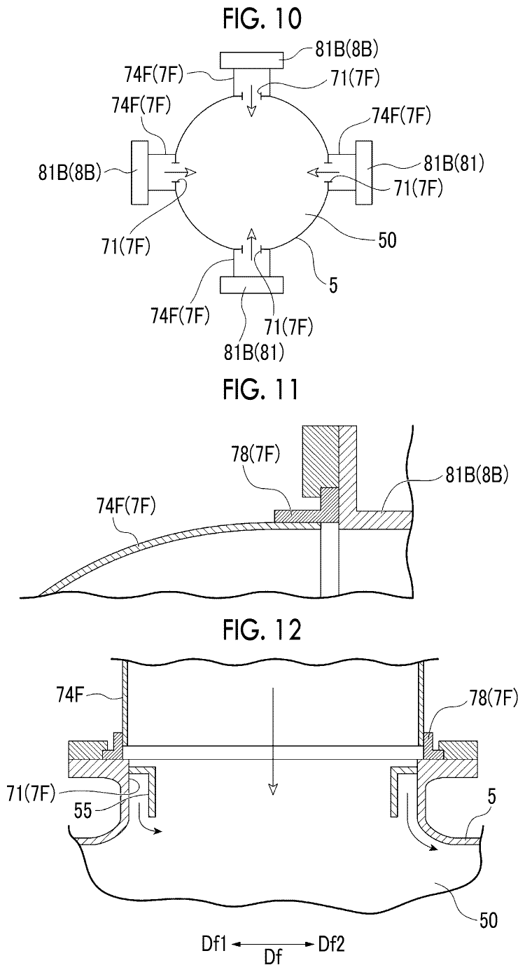

As shown in FIGS. 9 and 10, the intermediate supply section 7F according to the fifth embodiment does not include the annular flow channel forming section 73, and a connection flow channel section 74F is directly fixed to the outer peripheral surface of the cylindrical body 5. The connection flow channel section 74F is disposed to cover the communication hole 71. Therefore, the communication hole 71 according to the present embodiment connects the combustion chamber 50 and the connection flow channel section 74F. A plurality of connection flow channel sections 74F are disposed such that one connection flow channel section 74F is disposed with respect to one communication hole 71. That is, one connection flow channel section 74F is disposed to be able to block one communication hole 71. In addition, each of the plurality of connection flow channel sections 74F has an independent valve device 81B.

In addition, as shown in FIGS. 11 and 12, the intermediate supply section 7F includes a plurality of seal sections 78. The seal sections 78 are disposed between the connection flow channel section 74F and the valve device 81B and between the connection flow channel section 74F and the cylindrical body 5. The seal section 78 is a non-contact type seal that can be used in a high-temperature and high-pressure region, such as a floating ring seal.

In the structure as in the second embodiment, the seal section 78 may be disposed between the annular flow channel forming section 73 and the cylindrical body 5 or between the annular flow channel forming section 73 and the connection flow channel section 74F.

In addition, as shown in FIG. 12, the combustor 15 includes an annular sleeve section 55 that is disposed inside the cylindrical body 5 to surround the communication hole 71. The sleeve section 55 forms a flow channel through which cooling air can flow between the inner peripheral surface of the cylindrical body 5. In the sleeve section 55, similarly to a flow sleeve, a portion of the compressed air discharged from the compressor 14 is supplied as the cooling air.

In the structure as in the second embodiment, the sleeve section 55 may be disposed with respect to the communication hole 71 covered with the annular flow channel forming section 73.

### Operations and Effects

As described above, the valve device 81B that is independent of the other valve devices is disposed in each communication hole 71 via the connection flow channel section 74F. As a result, the valve device 81B can be regulated separately or simultaneously for each communication hole 71. Therefore, even in a case where any one of the ammonia fuel and the hydrocarbon-based fuel is supplied, the supply amount of the compressed air to the combustion chamber 50 can be appropriately regulated. Therefore, even in a case where temperature distribution or concentration distribution unevenness occurs in the cylindrical body 5 or the combustion chamber 50 depending on the operation state, the supply amount can be regulated to any value, and the generation amount of NOx can be easily suppressed.

Since the seal section 78 is disposed, even in a case where the high-temperature and high-pressure compressed air flows, the leakage of the compressed air from the connection portion between the respective members can be suppressed.

Further, since the sleeve section 55 is disposed, the vicinity of the communication hole 71 can be cooled. Therefore, it is possible to suppress the thermal expansion in the vicinity of the communication hole 71 due to the influence of the high-temperature combustion gas flowing through the combustion chamber 50.

### Sixth Embodiment

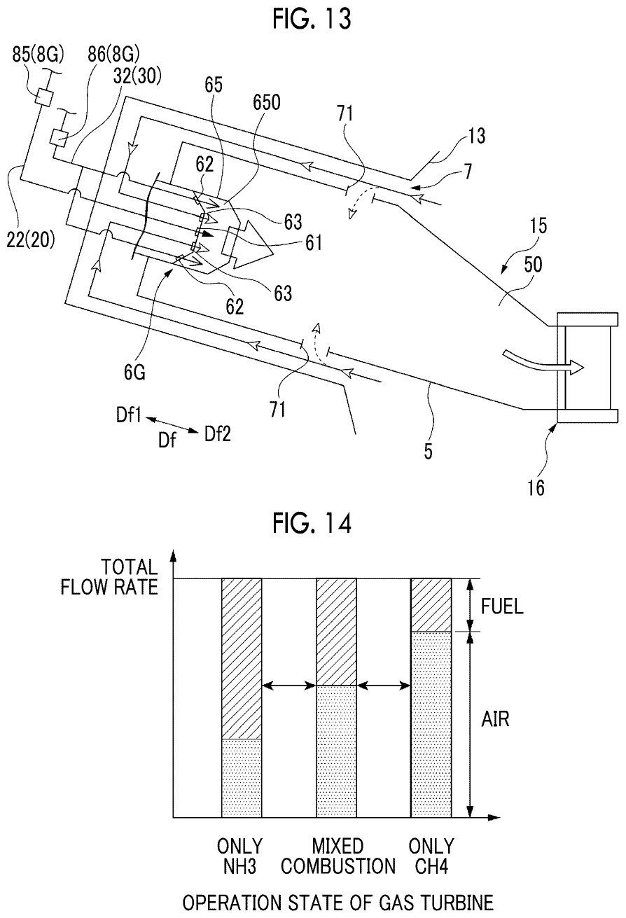

Next, a sixth embodiment of the gas turbine equipment 1 according to the present disclosure will be described with reference to FIGS. 13 and 14. In the following sixth embodiment, the configurations common to the configurations of the first to fifth embodiments will be denoted by the same reference numerals in the drawings, and description thereof will be omitted. In the sixth embodiment, the fuel nozzle 6G and a flow rate regulating section 8G are different.

The fuel nozzle 6G according to the sixth embodiment includes a mixing section 65 that forms a mixing space 650 in which the fluids jetted from the first jetting hole 61, the second jetting hole 62, and the third jetting hole 63 are mixed with each other before being supplied to the combustion chamber 50. The mixing section 65 forms a distal end portion connected to the combustion chamber 50 in the fuel nozzle 6G. The mixing section 65 is connected to the first jetting hole 61, the second jetting hole 62, and the third jetting hole 63. Only a predetermined amount of the fluid is allowed to flow into the mixing space 650. That is, in the fuel nozzle 6G according to the sixth embodiment, the ammonia fuel, the hydrocarbon-based fuel, and the compressed air, which are supplied, are mixed with each other and jetted as a certain amount of the fluid from the mixing section 65 to the combustion chamber 50. Accordingly, the supply amounts of the ammonia fuel, the hydrocarbon-based fuel, and the compressed air to the fuel nozzle 60 are limited to a certain amount.

The flow rate regulating section 8G is not limited to the structure including the valve device 81 or 81B as described in the first to fifth embodiments. That is, the flow rate regulating section 8G according to the sixth embodiment does not include the valve device 81 or 81B. The flow rate regulating section 8G according to the sixth embodiment sets the supply amounts of the ammonia fuel, the hydrocarbon-based fuel, and the compressed air to the fuel nozzle 60 to be constant, and then changes a ratio of the supply amounts of the ammonia fuel and the hydrocarbon-based fuel to the compressed air. As for the flow rate regulating section 8G, the supply amount of at least one of the ammonia fuel and the hydrocarbon-based fuel can be regulated, and thus the flow rate of the compressed air supplied to the cylindrical body 5 from the communication hole 71 can be regulated. In the sixth embodiment, as described above, the supply amounts of the ammonia fuel, the hydrocarbon-based fuel, and the compressed air to the fuel nozzle 6 are set to be constant by the mixing section 65. In such a state, the flow rate regulating section 8G can regulate the supply amount of at least one of the ammonia fuel and the hydrocarbon-based fuel such that the supply amount of the ammonia fuel when the ammonia fuel is supplied to the fuel nozzle 6G is larger than the supply amount of the hydrocarbon-based fuel when the hydrocarbon-based fuel is supplied to the fuel nozzle 6G. Specifically, the flow rate regulating section 8G according to the sixth embodiment includes a first supply amount regulating section 85 and a second supply amount regulating section 86 as shown in FIG. 13.

The first supply amount regulating section 85 regulates the supply amount of the ammonia fuel to the fuel nozzle 6G. The first supply amount regulating section 85 is disposed in the first supply line 22. The first supply amount regulating section 85 is, for example, a flow rate regulation valve, an on-off valve, or an electromagnetic valve. In a case where an opening degree of the first supply amount regulating section 85 is increased, the supply amount of the ammonia fuel from the first supply line 22 to the first jetting hole 61 is increased. Conversely, in a case where the opening degree of the first supply amount regulating section 85 is decreased, the supply amount of the ammonia fuel from the first supply line 22 to the first jetting hole 61 is reduced.

The second supply amount regulating section 86 regulates the supply amount of the hydrocarbon-based fuel to the fuel nozzle 6G. The second supply amount regulating section 86 is disposed in the second supply line 32. The second supply amount regulating section 86 is, for example, a flow rate regulation valve, an on-off valve, or a solenoid valve. In a case where an opening degree of the second supply amount regulating section 86 is increased, the supply amount of the hydrocarbon-based fuel from the second supply line 32 to the second jetting hole 62 is increased. On the contrary, in a case where the opening degree of the second supply amount regulating section 86 is decreased, the supply amount of the hydrocarbon-based fuel from the second supply line 32 to the second jetting hole 62 is reduced. In addition, even in the fully open state, the second supply amount regulating section 86 has a lower flow rate at which the flow can be performed in the second supply line 32 than the flow rate in the fully open state of the first supply amount regulating section 85. That is, in a case where both the first supply amount regulating section 85 and the second supply amount regulating section 86 are in the fully open state, the supply amount of the ammonia fuel is larger than the supply amount of the hydrocarbon-based fuel. Specifically, it is preferable that, based on a ratio of the calorific value of the ammonia fuel to the calorific value of the hydrocarbon-based fuel, the second supply amount regulating section 86 can allow the flow at the flow rate of an inverse ratio of the ratio with respect to the first supply amount regulating section 85. More specifically, in a case where the calorific value of the hydrocarbon-based fuel and a Wobbe index (WI) are about four times the calorific value of the ammonia fuel, the second supply amount regulating section 86 can allow the flow up to the flow rate of only up to about ¼ with respect to the first supply amount regulating section 85.

### Operations and Effects

As shown in FIG. 14, the flow rate regulating section 8G regulates the supply amounts of the ammonia fuel and the hydrocarbon-based fuel and the compressed air to the fuel nozzle 6G. Specifically, in a case where both the ammonia fuel and the hydrocarbon-based fuel are supplied, as shown in “mixed combustion” of FIG. 14, the first supply amount regulating section 85 and the second supply amount regulating section 86 are regulated such that a radio between a total value of the supply amounts of the ammonia fuel and the hydrocarbon-based fuel and the supply amount of the compressed air is close to 1:1.

In addition, when only the ammonia fuel is supplied, as shown in “only NH3” of FIG. 14, the regulation is performed in which the first supply amount regulating section 85 is opened and the second supply amount regulating section 86 is closed such that the supply amount of the ammonia fuel is larger than the supply amount of the compressed air. As a result, in the mixing space 650, more ammonia fuel is supplied from the first jetting hole 61 as compared with a case of “mixed burning”, and less compressed air is supplied from the third jetting hole 63. Then, a large amount of the compressed air that cannot flow into the third jetting hole 63 is supplied to the combustion chamber SO from the communication hole 71. As a result, most of the compressed air in the intermediate casing 13 flows into the combustion chamber 50 from the communication hole 71. That is, a portion of the compressed air that is to be supplied to the third jetting hole 63 directly flows into the combustion chamber 50 from the communication hole 71.

In addition, when only the hydrocarbon-based fuel is supplied, as shown in “Only CH4” of FIG. 14, the regulation is performed in which the first supply amount regulating section 85 is closed and the second supply amount regulating section 86 is opened such that the supply amount of the hydrocarbon-based fuel is larger than the supply amount of the compressed air. Further, the second supply amount regulating section 86 is configured to perform the flow up to only a very small flow rate with respect to the first supply amount regulating section 85. Therefore, the flow rate of the compressed air flowing into the mixing space 650 from the third jetting hole 63 in a case of “only CH4” is larger than in a case of “only NH3” or a case of “mixed combustion”. As a result, the amount of the compressed air that cannot flow into the third jetting hole 63 is reduced. As a result, the compressed air in the intermediate casing 13 does not flow into the combustion chamber 50 from the communication holes 71. That is, the flow rate of the compressed air used in the fuel nozzle 6 can be increased in a case where the hydrocarbon-based fuel is used as compared with a case where the ammonia fuel is used.

In this way, the flow rate of the compressed air used in the fuel nozzle 6 can be regulated by regulating the supply amount of the ammonia fuel and the supply amount of the hydrocarbon-based fuel. Therefore, it is not necessary to always dispose the valve device 81 or 81B, and it is possible to suppress the generation amount of NOx while continuing stable combustion with a simpler configuration or control of only changing the supply amount of the ammonia fuel and the supply amount of the hydrocarbon-based fuel, regardless of whether the ammonia fuel or the hydrocarbon-based fuel is supplied. Therefore, it is possible to effectively achieve both the combustion with the ammonia fuel and the combustion with the hydrocarbon-based fuel.

As described above, the flow rate regulating section 8G according to the sixth embodiment can be applied to a structure in which the valve device 81 or 81B is not provided, but may be applied to a structure in which the valve device 81 or 81B is further provided.

### Seventh Embodiment

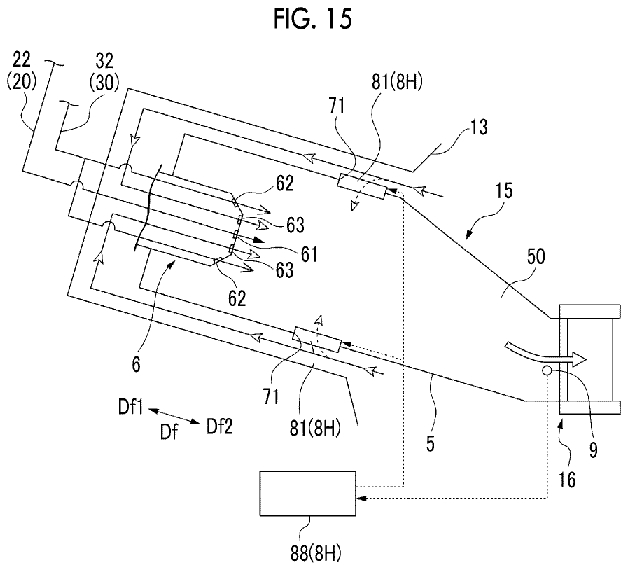

Next, a seventh embodiment of the gas turbine equipment 1 according to the present disclosure will be described with reference to FIG. 15. In the following seventh embodiment, the configurations common to the configurations of the first to sixth embodiments will be denoted by the same reference numerals in the drawings, and description thereof will be omitted. The seventh embodiment is different from the sixth embodiment in that a flow rate regulating section SH regulates the flow rate based on the operation state of the combustor 15.

The gas turbine 10 according to the seventh embodiment further includes a detection section 9 that detects the operation state of the combustor 15. Specifically, the detection section 9 according to the present embodiment detects the temperature in the combustor 15. The detection section 9 need only be a device that can detect the operation state of the combustor 15. That is, the detection section 9 need only be a device capable of ascertaining the supply states of the ammonia fuel, the hydrocarbon-based fuel, and the compressed air. For example, the detection section 9 may be a device that detects at least one of the supply amount or the temperature of the ammonia fuel, the supply mount or the temperature of the hydrocarbon-based fuel, and the supply amount or the temperature of the compressed air with respect to the fuel nozzle 6. In addition, the detection section 9 may be a device that detects the temperature of the combustion gas in the vicinity of the inflow into the turbine 16, the concentration of NOx included in the exhaust gas, and the concentration of ammonia that is an unburned component included in the exhaust gas. Further, the detection section 9 may detect a plurality of states of a state of the fluid to be supplied and a state of the combustion result in the combustor 15.

In addition, the flow rate regulating section 8H according to the seventh embodiment includes a valve control device 88 that controls the valve device 81 based on the detection result of the detection section 9. The valve control device 88 can regulate the flow rate of the compressed air supplied to the combustion chamber 50 by changing the opening degree of the valve device 81 in accordance with the detection result of the detection section 9. Specifically, in a case where the temperature of the combustor 15 detected by the detection section 9 exceeds a first threshold value, the valve control device 88 issues an instruction to reduce the opening degree of the valve device 81. The first threshold value is, for example, a value of a temperature corresponding to a case where the supply of the hydrocarbon-based fuel is started from a state in which only the ammonia fuel is supplied to the fuel nozzle 6, and is switched to a mixed combustion state of the ammonia fuel and the hydrocarbon-based fuel. Further, in a case where the temperature of the combustor 15 detected by the detection section 9 exceeds a second threshold value larger than the first threshold value, the valve control device 88 issues an instruction to further reduce the opening degree of the valve device 81 (for example, to the fully closed state). The second threshold value is, for example, a value of a temperature corresponding to a case where a state is switched from the mixed combustion state in which both the ammonia fuel and the hydrocarbon-based fuel are supplied to a state in which the supply of the ammonia fuel is stopped and only the hydrocarbon-based fuel is supplied to the fuel nozzle 6.

The valve control device 88 described above is a computer. The hardware of the valve control device 88 includes a central processing unit (CPU) that performs various operations, a main storage device such as a memory that is a work area of the CPU, an auxiliary storage device such as a hard disk drive device, an input device such as a keyboard or a mouse, and a display device. The valve control device 88 may be incorporated in a control device (not shown) of the gas turbine equipment 1 as a part of the functions.

### Operations and Effects

As described above, by controlling the valve device 81 via the valve control device 88 based on the detection result of the detection section 9, the flow rate of the compressed air fed into the combustion chamber 50 from the communication hole 71 by the valve device 81 can be regulated without delay depending on the operation state of the combustor 15. Further, it is possible to suppress the generation amount of NOx while continuing stable combustion even at the timing of switching the supply of the ammonia fuel and the hydrocarbon-based fuel.

In addition, in the ammonia fuel and the hydrocarbon-based fuel, the calorific value of the hydrocarbon-based fuel is much higher than the calorific value of the ammonia fuel. Therefore, in a case where the temperature of the combustor 15 is detected by the detection section 9, it is possible to easily ascertain the supply amounts of the ammonia fuel and the hydrocarbon-based fuel that are being supplied.

### Other Embodiments

Although the embodiments of the present disclosure have been described in detail with reference to the drawings, the specific configuration is not limited to these embodiments and includes, for example, a design change without departing from the gist of the present disclosure.

The gas turbine equipment 1 described above is not limited to the structure described in the present embodiment. For example, as other configurations, the gas turbine equipment 1 may include a control device that controls various devices, a denitration device that decomposes NOx included in the exhaust gas from the gas turbine 10, and a chimney that discharges the exhaust gas flowing out from the denitration device to the outside.

In addition, the combustor 15 described above is not limited to the structure described in the present embodiment. That is, the combustor 15 may have a configuration (for example, an acoustic damper or the like) other than the cylindrical body 5, the fuel nozzle 6 or 60, the intermediate supply section 7, 7B, 7C, 7D, 7E, or 7F, and the flow rate regulating section 8, 8B, 8G, or 8H.

In addition, the embodiment of the fuel nozzle 6 or 6G is not limited to the above-described structure. The fuel nozzle 6 or 6G may be any type of nozzle having any form, such as a type (premixing combustion type) for premixing fuel and air, a type for rapidly mixing fuel and air as in the present embodiment (diffusion combustion type), or a type for independently jetting fuel and air.

In addition, the regulation of the supply state of the ammonia fuel to the fuel nozzle 6 or 6G from the ammonia fuel supply equipment 20 and the regulation of the supply state of the hydrocarbon-based fuel to the fuel nozzle 6 or 6G from the hydrocarbon-based fuel supply equipment 30 may be manually performed by a worker or may be automatically performed by a control device or the like of the gas turbine equipment 1.

In addition, in the present embodiment, the ammonia fuel supply equipment 20 supplies the gaseous-state ammonia fuel to the gas turbine 10, but the present disclosure is not limited to such a configuration. As long as the gas turbine 10 has a structure capable of receiving the liquid-state ammonia fuel, the ammonia fuel supply equipment 20 may supply the liquid-state ammonia fuel to the gas turbine 10.

Similarly, the valve device 81 or 81B, the first supply amount regulating section 85, and the second supply amount regulating section 86 may be manually controlled by a worker or may be automatically controlled by a control device or the like of the gas turbine equipment 1.

In addition, the intermediate supply section 7, 7B, 7C, 7D, 7E, or 7F is not limited to the structure including the communication holes 71 as described in the present embodiment. The intermediate supply section 7, 7B, 7C, 7D, 7E, or 7F need only have a structure in which a portion of the compressed air supplied to the fuel nozzle 6 or 6G can be supplied to the cylindrical body 5, on the downstream side Df2 of the fuel nozzle 6 or 6G in the flow direction Df of the combustion gas. Therefore, the intermediate supply section 7, 7B, 7C, 7D, 7E, or 7F may have a structure in which the compressed air compressed by the compressor 14 is extracted and supplied to the cylindrical body 5 by, for example, a pipe or the like.

### Supplementary Notes

The gas turbine 10 and the gas turbine equipment 1 according to each of the embodiments can be understood, for example, as follows.

(1) A first aspect provides a gas turbine 10 including: a compressor 14 configured to compress air to generate compressed air; a combustor 15 in which a fuel to be burned is switchable between an ammonia fuel and a hydrocarbon-based fuel, the combustor 15 being configured to burn at least one of the ammonia fuel or the hydrocarbon-based fuel in the compressed air supplied from the compressor 14 to generate a combustion gas; and a turbine 16 drivable by the combustion gas supplied from the combustor 15, in which the combustor 15 includes a cylindrical body 5 that has a cylindrical shape and through which the combustion gas generated by combustion of the ammonia fuel or the hydrocarbon-based fuel flows, a fuel nozzle 6 or 6G that jets the ammonia fuel, the hydrocarbon-based fuel, and the compressed air into the cylindrical body 5, an intermediate supply section 7, 7B, 7C, 7D, 7E, or 7F that supplies a portion of the compressed air supplied to the fuel nozzle 6 or 6G to the cylindrical body 5, on a downstream side Df2 of the fuel nozzle 6 or 6G in a flow direction Df of the combustion gas, and a flow rate regulating section 8, 8B, 8G, or 8H that regulates a flow rate of the compressed air supplied from the intermediate supply section 7, 7B, 7C, 7D, 7E, or 7F to the cylindrical body 5 with respect to a supply amount of the compressed air supplied to the fuel nozzle 6 or 6G, and the flow rate regulating section 8, 8B, 8G, or 8H increases the flow rate of the compressed air supplied from the intermediate supply section 7, 7B, 7C, 7D, 7E, or 7F to the cylindrical body 5 when the ammonia fuel is burned and decreases the flow rate of the compressed air supplied to the cylindrical body 5 when the hydrocarbon-based fuel is burned.

Accordingly, when the combustion gas is generated by using the ammonia fuel, the flow rate of the compressed air used for the combustion can be reduced by the fuel nozzle 6. As a result, in a case where the ammonia fuel is burned, it is possible to suppress the occurrence of unstable combustion due to excessive supply of the compressed air. Accordingly, in a case where the ammonia fuel is burned, stable combustion can be continued and the flame bolding property can be maintained.

In a case where the supply amount of the compressed air is reduced, the proportion of the ammonia fuel in the ratio between the supply amounts of the ammonia fuel and the compressed air is increased. As a result, the amount of the nitrogen component remaining in the combustion gas derived from nitrogen in the ammonia fuel can be significantly reduced. Therefore, the generation amount of NOx when the ammonia fuel is burned can be suppressed.

Further, when the hydrocarbon-based fuel is used to generate the combustion gas, the flow rate of the compressed air used for the combustion can be increased by the fuel nozzle 6. As a result, it is possible to secure a required amount of the compressed air to be supplied to the fuel nozzle 6 or 6G when the hydrocarbon-based fuel is burned. Accordingly, even in a case where the hydrocarbon-based fuel is burned, stable combustion can be continued and the flame holding property can be maintained.

In a case where the supply amount of the compressed air is increased, the proportion of the hydrocarbon-based fuel in the ratio between the supply amounts of the hydrocarbon-based fuel and the compressed air is decreased. As a result, the amount of the nitrogen component remaining in the combustion gas derived from nitrogen in the compressed air can be significantly reduced. Therefore, the generation amount of NOx when the hydrocarbon-based fuel is burned can be suppressed.

In this way, in the gas turbine 10 to which the ammonia fuel and the hydrocarbon-based fuel are supplied, the generation amount of NOx can be suppressed while continuing stable combustion, regardless of whether the ammonia fuel or the hydrocarbon-based fuel is supplied. Therefore, it is possible to effectively achieve both the combustion with the ammonia fuel and the combustion with the hydrocarbon-based fuel.

(2) A second aspect provides the gas turbine 10 according to (1), in which the flow rate regulating section 8, 8B, 8G, or 8H includes a valve device 81 or 81B configured to regulate a flow rate of the compressed air flowing into the cylindrical body 5.

Accordingly, the supply amount of the compressed air in a case where the ammonia fuel is supplied and in a case where the hydrocarbon-based fuel is supplied can be regulated by a simple configuration,

(3) A third aspect provides the gas turbine 10 according to (1) or (2), in which the intermediate supply section 7, 7B, 7C, 7D, 7E, or 7F includes a communication hole 71 that allows an inside and an outside of the cylindrical body 5 to communicate with each other at a position that is separated from the fuel nozzle 6 and that is located on the downstream side Df2 of the fuel nozzle 6 or 6G in the flow direction Df of the combustion gas.

Accordingly, the compressed air that has flowed into the combustion chamber 50 from the communication hole 71 does not directly participate in the combustion. Therefore, a structure in which the compressed air can be supplied to the combustion chamber 50 while securing a space for stably burning the ammonia fuel and the hydrocarbon-based fuel supplied from the fuel nozzle 6 or 6G can be obtained by a simple configuration.

(4) A fourth aspect provides the gas turbine 10 according to (3), in which the communication holes 71 are formed in the cylindrical body 5 at a plurality of positions separated from each other.

Accordingly, the compressed air supplied to the cylindrical body 5 is supplied to the combustion chamber 50 without being largely biased to the vicinity of the inner peripheral surface of a part of the cylindrical body 5. Therefore, the generation amount of NOx can be effectively suppressed while continuing stable combustion with high efficiency in a wide region of the combustion chamber 50, regardless of whether the ammonia fuel or the hydrocarbon-based fuel is supplied.

(5) A fifth aspect provides the gas turbine 10 according to (3) or (4), in which the intermediate supply section 7B, 7C, 7D, or 7E includes an annular flow channel forming section 73 that forms an annular flow channel 730 through which the compressed air is able to flow along an outer periphery of the cylindrical body 5, and the communication hole 71 allows the annular flow channel forming section 73 and the cylindrical body 5 to communicate with each other.

Accordingly, the annular flow channel forming section 73 plays a role of a damper, and thus the compressed air present in the annular flow channel 730 is in a nearly uniform pressure state. Thereafter, the compressed air flows into the combustion chamber 50 from the communication hole 71 while filling the annular flow channel 730. Accordingly, the compressed air in a nearly uniform pressure state can be supplied from the communication hole 71 to the combustion chamber 50 by the annular flow channel forming section 73. Therefore, the generation amount of NOx can be further effectively suppressed while continuing stable combustion more efficiently in a wide region of the combustion chamber 50, regardless of whether the ammonia fuel or the hydrocarbon-based fuel is supplied.

(6) A sixth aspect provides the gas turbine 10 according to (5), in which the annular flow channel forming section 73 is disposed to have a gap 770 with an outer peripheral surface of the cylindrical body 5.

Accordingly, even in a case where the thermal expansion of the cylindrical body 5 occurs due to the influence of the high-temperature combustion gas flowing through the combustion chamber 50, the thermal expansion amount can be absorbed without affecting the annular flow channel forming section 73. Accordingly, the fixed state of the annular flow channel forming section 73 and the cylindrical body 5 can be stably maintained.

(7) A seventh aspect provides the gas turbine 10 according to any one of (3) to (6), in which the intermediate supply section 7D or 7E includes a supply pipe 76 that is disposed in the communication hole 71 and that is formed in a tubular shape extending inward from an inner peripheral surface of the cylindrical body 5.

Accordingly, the compressed air flowing into the combustion chamber 50 from the communication hole 71 is fed to a portion deeper than the inner peripheral surface of the cylindrical body 5 by the supply pipe 76. Accordingly, the compressed air can be stably supplied to a deep portion of the combustion chamber 50 separated from the communication hole 71.

(8) An eighth aspect provides the gas turbine 10 according to any one of (1) to (7), in which the flow rate regulating section 8, 8B, 8G, or 8H is configured to set supply amounts of the ammonia fuel, the hydrocarbon-based fuel, and the compressed air to the fuel nozzle 6 or 6G and then regulate the supply amount of at least one of the ammonia fuel and the hydrocarbon-based fuel such that the supply amount of the ammonia fuel when the ammonia fuel is supplied to the fuel nozzle 6 or 6G is larger than the supply amount of the hydrocarbon-based fuel when the hydrocarbon based fuel is supplied to the fuel nozzle 6 or 6G.

Accordingly, the flow rate of the compressed air used in the fuel nozzle 6 can be regulated by regulating the supply amount of the ammonia fuel and the supply amount of the hydrocarbon-based fuel. Therefore, it is not necessary to always dispose the valve device 81 or 81B, and it is possible to suppress the generation amount of NOx while continuing stable combustion with a simpler configuration or control of only changing the supply amount of the ammonia fuel and the supply amount of the hydrocarbon-based fuel, regardless of whether the ammonia fuel or the hydrocarbon-based fuel is supplied.

(9) A ninth aspect provides the gas turbine 10 according to any one of (1) to (8), further including: a detection section 9 that detects an operation state of the combustor 15, in which the flow rate regulating section 8, 8B, 8G, or 8H regulates the flow rate of the compressed air supplied to the cylindrical body 5 in accordance with a detection result of the detection section 9.

Accordingly, the flow rate of the compressed air to be fed into the combustion chamber 50 by the flow rate regulating section 8, 8B, 8G, or 8H can be regulated without delay depending on the operation state of the combustor 15. Further it is possible to suppress the generation amount of NOx while continuing stable combustion even at the timing of switching the supply of the ammonia fuel and the hydrocarbon-based fuel.

(10) A tenth aspect provides gas turbine equipment 1 including: the gas turbine 10 according to any one of (1) to (9); ammonia fuel supply equipment 20 configured to supply the ammonia fuel to the gas turbine 10; and hydrocarbon-based fuel supply equipment 30 configured to supply the hydrocarbon-based fuel to the gas turbine 10.

### INDUSTRIAL APPLICABILITY

With the gas turbine and the gas turbine equipment according to the present disclosure, it is possible to suppress the generation amount of NOx while continuing stable combustion in the gas turbine to which the ammonia fuel and the hydrocarbon-based fuel are supplied.

### REFERENCE SIGNS LIST

1: gas turbine equipment
10: gas turbine
11: gas turbine rotor
12: air intake duct
13: intermediate casing
14: compressor
14r: compressor rotor
14c: compressor casing
14v: IGV
15: combustor
5: cylindrical body
50: combustion chamber
6, 6G: fuel nozzle
61: first jetting hole
62: second jetting hole
63: third jetting hole
7, 7B, 7C, 7D, 7E, 7F: intermediate supply section
71: communication hole
8, 8B, 8G, 8H: flow rate regulating section
81, 81B: valve device
Df: flow direction
Df1: upstream side
Df2: downstream side
16: turbine
16r: turbine rotor
16c: turbine casing
Ar: rotor axis line
20: ammonia fuel supply equipment
21: first storage tank
22: first supply line
30: hydrocarbon-based fuel supply equipment
31: second storage tank
32: second supply line
73, 73C: annular flow channel forming section
730: annular flow channel
75: welding section
74, 74C, 74F: connection flow channel section
76: supply pipe
77: gap forming member
770: gap
78: seal section
55: sleeve section
85: first supply amount regulating section
86: second supply amount regulating section
65: mixing section
650: mixing space
9: detection section
88: valve control device

1. A gas turbine comprising:
a compressor configured to compress air to generate compressed air;
a combustor in which a fuel to be burned is switchable between an ammonia fuel and a hydrocarbon-based fuel, the combustor being configured to burn at least one of the ammonia fuel or the hydrocarbon-based fuel in the compressed air supplied from the compressor to generate a combustion gas; and
a turbine drivable by the combustion gas supplied from the combustor,
wherein the combustor includes
a cylindrical body that has a cylindrical shape and through which the combustion gas generated by combustion of the ammonia fuel or the hydrocarbon-based fuel flows,
a fuel nozzle that jets the ammonia fuel, the hydrocarbon-based fuel, and the compressed air into the cylindrical body,
an intermediate supply section that supplies a portion of the compressed air supplied to the fuel nozzle to the cylindrical body, on a downstream side of the fuel nozzle in a flow direction of the combustion gas, and
a flow rate regulating section configured to regulate a flow rate of the compressed air supplied from the intermediate supply section to the cylindrical body with respect to a supply amount of the compressed air supplied to the fuel nozzle, and
the flow rate regulating section increases the flow rate of the compressed air supplied from the intermediate supply section to the cylindrical body when the ammonia fuel is burned and decreases the flow rate of the compressed air supplied to the cylindrical body when the hydrocarbon-based fuel is burned.

2. The gas turbine according to claim 1,
wherein the flow rate regulating section includes a valve device configured to regulate a flow rate of the compressed air flowing into the cylindrical body.

3. The gas turbine according to claim 1,
wherein the intermediate supply section includes a communication hole that allows an inside and an outside of the cylindrical body to communicate with each other at a position that is separated from the fuel nozzle and that is located on the downstream side of the fuel nozzle in the flow direction of the combustion gas.

4. The gas turbine according to claim 3,
wherein the communication holes are formed in the cylindrical body at a plurality of positions separated from each other.

5. The gas turbine according to claim 4,
wherein the intermediate supply section includes an annular flow channel forming section that forms an annular flow channel through which the compressed air is able to flow along an outer periphery of the cylindrical body, and
the communication hole allows the annular flow channel forming section and the cylindrical body to communicate with each other.

6. The gas turbine according to claim 5,
wherein the annular flow channel forming section is disposed to have a gap with an outer peripheral surface of the cylindrical body.

7. The gas turbine according to claim 5,
wherein the intermediate supply section includes a supply pipe that is disposed in the communication hole and that is formed in a tubular shape extending inward from an inner peripheral surface of the cylindrical body.

8. The gas turbine according to claim 1,
wherein the flow rate regulating section is configured to set supply amounts of the ammonia fuel, the hydrocarbon-based fuel, and the compressed air to the fuel nozzle and then regulate the supply amount of at least one of the ammonia fuel and the hydrocarbon-based fuel such that the supply amount of the ammonia fuel when the ammonia fuel is supplied to the fuel nozzle is larger than the supply amount of the hydrocarbon-based fuel when the hydrocarbon-based fuel is supplied to the fuel nozzle.

9. The gas turbine according to claim 1, further comprising:
a detection section that detects an operation state of the combustor,
wherein the flow rate regulating section regulates the flow rate of the compressed air supplied to the cylindrical body in accordance with a detection result of the detection section.

10. Gas turbine equipment comprising:
the gas turbine according to claim 1;
ammonia fuel supply equipment configured to supply the ammonia fuel to the gas turbine; and
hydrocarbon-based fuel supply equipment configured to supply the hydrocarbon-based fuel to the gas turbine.
